(19) United States
(12) Patent Application Publication
(10) Pub. No.: US 2025/0256495 A1
(43) Pub. Date: Aug. 14, 2025

(54) SOLUBLE PAPER AND FILM LAMINATES

(71) Applicant: Neenah, Inc., Alpharetta, GA (US)

(72) Inventors: Krystyna deVries, Renfrew (CA); Simon Terry, Alpharetta, GA (US); Richard E. Kajander, Alpharetta, GA (US)

(21) Appl. No.: 19/051,765

(22) Filed: Feb. 12, 2025

Related U.S. Application Data
(60) Provisional application No. 63/553,239, filed on Feb. 14, 2024.

(51) Int. Cl. B32B 27/10; B32B 27/30; B32B 37/00; B32B 37/06; B32B 37/10; B32B 38/00; B65D 65/40; B65D 65/46

(52) U.S. Cl. CPC B32B 27/10; B32B 27/30; B32B 37/0038; B32B 37/06; B32B 37/10; B32B 38/145; B65D 65/40; B65D 65/46; B32B 2250/02; B32B 2307/7166; B32B 2307/7376

(57) ABSTRACT

A soluble laminate, a laminated paper, and a packaging material including the soluble laminate are provided. The laminate may include a first layer including a paper and a second layer including a film. The paper and the film may be at least partially soluble. The first layer may include a first paper surface and a second paper surface. The first paper surface may face towards the second layer, and the second paper surface may face away from the second layer. The second layer may have a first film surface and a second film surface. The first film surface may face away from the first layer and the second film surface may face toward the first layer. At least some of the first paper surface and at least some of the second film surface may be partially dissolved and adhered to one another.

### CROSS-REFERENCE TO RELATED APPLICATIONS

This application claims the benefit of U.S. Provisional Application No. 63/553,239 filed Feb. 14, 2024, the complete disclosure of which is incorporated herein by reference for all purposes.

### TECHNICAL FIELD

Provided herein are paper and film laminates, and more specifically soluble laminates formed from soluble paper and soluble film.

### BACKGROUND

Water soluble papers are commonly employed in commercial applications. Some of these commercial applications include, for example, packaging for food, pharmaceuticals, washing detergents, etc. Water soluble papers are attractive materials for these types of packaging applications due to their biodegradability. However, uncoated water-soluble paper packaging materials are often susceptible to quick degradation from water, moisture, or gas when used for this purpose.

Therefore, such water-soluble papers are often coated with a water-soluble film to increase the integrity of the material for packaging purposes. Typically, water soluble papers and water-soluble films are combined together using, e.g., an adhesive, a glue, or other type of polymer (collectively referred to as “adhesives” hereinafter), therebetween during the manufacturing process.

U.S. Patent Publication No. 2022/0112663 to Boswell et al. discloses a biodegradable and recyclable barrier paper laminate that includes an inorganic barrier layer against permeation to avoid the aforementioned problems with uncoated papers. Boswell et al. discloses, for example in Example 1, a polyvinyl alcohol (commonly referred to as, e.g., PVA or PHOV) coated paper for use in packaging. The coating requires an adhesive layer to attach to the paper.

Currently, protective films or coatings are typically adhered to water soluble papers with an adhesive, such as described by Boswell et al. as an example. However, it would be desirable to provide a soluble laminate that comprises a soluble paper adhered to a soluble film, without the need for an additional adhesive. This improved laminate would then ensure a fully and completely dissolvable laminate that does not leave behind any adhesive material, and which would provide a more simplified manufacturing process, by eliminating the step of applying an adhesive before applying a film or coating to the paper.

### SUMMARY

As will be set forth in greater detail below, there is provided a soluble laminate, a laminated paper, and a packaging material comprising a soluble laminate, in which the laminate comprises a soluble paper and a soluble film that are adhered together. A method of making such a soluble laminate is also provided.

The soluble laminate and the products formed from the laminate eliminate the need for an adhesive or other bonding layer between the paper and film. The paper and film may be water soluble, making the resultant laminate water soluble. Instead of using an adhesive between the water-soluble paper and the water-soluble film, water may be employed for wetting the water-soluble paper and water-soluble film to allow the paper and film to adhere to one another, resulting in, e.g., a simpler manufacturing process and a more optimal final laminate product.

It should be noted that the effectiveness of using water to laminate a water-soluble paper with a water-soluble film is highly unexpected, as water would typically be assumed to dissolve the water-soluble paper and/or the water-soluble film during the manufacturing process and thereby destroy the laminate during such process and before it can result in a final product. However, as will be described herein, the present process for making the laminate effectively controls the degree or level of wetness of the paper and film to avoid over-dissolving either of the paper or film. The result is a laminate in which the paper is adhered to the film, without compromising the integrity of the paper and the overall laminate.

Thus, in accordance with one aspect, there is provided a laminate that includes a soluble paper and a soluble film. In one embodiment, the paper and film are water soluble. However, it is contemplated that the paper and film may also be soluble in a liquid other than water as well. The film is in direct contact with, and adhered to, the paper without an intermediate layer of adhesive between the film and the paper. For example, in embodiments, the water-soluble film may be directly laminated onto the water-soluble paper by wetting the contact surfaces of the paper and film with only water, e.g., during the manufacturing process. Advantageously, the resulting laminate is suitable to be printed thereon.

In one exemplary embodiment, the laminate comprises a first layer and a second layer. The first layer may comprise a paper that is at least partially soluble. The second layer may comprise a film that is at least partially soluble. The first layer has a first paper surface facing towards the second layer, and a second paper surface facing away from the second layer. The second layer has a first film surface facing away from the first layer, and a second film surface facing towards the first layer. At least some of the first paper surface and at least some of the second film surface is partially dissolved during manufacturing to enable the first paper surface and the second film surface to adhere to one another.

Any type of soluble paper is contemplated. Suitable types of soluble paper may include any liquid or water-soluble paper. The paper may be, in one example, a water-soluble filamentous paper formed by a paper machine, a web, or it may be spunbond, meltblown, airlaid, or needle punched.

In certain embodiments, the water-soluble paper may be a cellulose-based paper. Furthermore, the cellulose-based paper may include a cellulose derivative or other additives. Suitable additives may include, for example, aqueous based, water re-dispersible adhesives including, but not limited to, one or more of carboxymethyl cellulose (CMC), hydroxyethyl cellulose (HEC), starches, starch derivatives, alginates, xanthan, pectins, cellulose gums, sugars, polyethylene glycol (PEG), polyvinyl alcohol (PVOH), polyvinylpyrrolidone (PVP), polyacrylamides, hydrophilic acrylic copolymers, or the like, or any combination thereof.

Still further, the cellulose-based paper may include a thickener, such as a carboxymethyl cellulose thickener, or a thickener including HEC, starches, starch derivatives, alginates, xanthan (e.g., xanthan gum), pectins, cellulose gums, sugars, PEG, PVOH, PVP, polyacrylamides, hydrophilic acrylic copolymers, etc. as long as they do not impede the dissolution of the final laminate.

In an embodiment, the water-soluble paper may be Dispersa® (a product publicly available from Neenah Industrials Solutions, Alpharetta, GA). The water-soluble paper may have a thickness of from about 0.02 to about 0.90 millimeters (mm). It should be appreciated that the thickness may be determined according to conventional methods, such as via a micrometer.

Any type of soluble film is also contemplated. Suitable types of soluble film may include any liquid or water-soluble film. For example, the film may include a water-soluble polymer such as polyvinylpyrrolidone (PVP) or polyvinyl alcohol (PVA/PVOH). In certain embodiments, the water-soluble film may include an alcohol, e.g., a polyvinyl alcohol (PVA/PVOH). In some embodiments, the water-soluble film may be MonoSol™ (a product publicly available from Kuraray™ Company, Merrillville, IN). The water-soluble film may have a thickness of from about 0.01 to about 0.40 millimeters (mm).

It should be understood that what is meant by soluble is that a majority of the material is soluble in liquid, but that modest amounts of insoluble artifacts may be present without negative effects. For instance, modest amounts of insoluble co-polymers at very small amounts <5% may be acceptably present in the soluble film. Furthermore, it is understood that only some of the contact surfaces of the paper and film need to be wetted or dissolved in order for the paper and film to adhere together. The entire surface area of the contact surfaces is not required to be wetted or dissolved in order to achieve adhesion of the film to the paper. It should be appreciated that wetting the respective surfaces may soften and/or increase tackiness thereof, thereby facilitating the adhesion without an adhesive.

In another aspect, there is provided a process for forming such a laminate. The process may comprise the step of providing a first layer comprising a paper that is at least partially soluble, the paper having a first paper surface and a second paper surface. The process may further comprise providing a second layer comprising a film that is at least partially soluble the film having a first film surface and a second film surface. The process may also include the step of wetting the first paper surface with a liquid and then applying the second layer onto the first layer such that the second film surface faces and adheres to the first paper surface.

In embodiments, the applying step may include placing the second layer onto the first layer between rollers. The rollers may be heated rollers. The step of wetting may include applying the liquid to at least partially dissolve, wet, and/or soften the first paper surface. The liquid may be water, in one example. The step of wetting should only partially dissolve, wet, and/or soften the first paper surface, and not result in the entire first layer being penetrated with the water or liquid. It should be appreciated that partially dissolving, wetting, and/or softening the first paper surface may increase a tackiness thereof, thereby facilitating the adhesion of the first paper surface with the film.

In still another aspect, there is provided a laminated paper that comprises a first layer and a second layer. The first layer may comprise a paper that is at least partially soluble. The second layer may comprise a film that is at least partially soluble. The first layer has a first paper surface facing towards the second layer, and a second paper surface facing away from the second layer. The second layer has a first film surface facing away from the first layer, and a second film surface facing towards the first layer. At least some of the first paper surface and at least some of the second film surface is partially dissolved during manufacturing to enable the first paper surface and the second film surface to adhere to one another.

In certain embodiments, the paper may be a cellulose-based paper. Furthermore, the cellulose-based paper may include a cellulose derivative or other additives. The paper may also or alternatively include a thickener. In some embodiments, the film may include a water-soluble polymer such as polyvinylpyrrolidone (PVP) or polyvinyl alcohol (PVA/PVOH).

In yet another aspect, there is provided a packaging material for containing a product. The packaging material may comprise a soluble laminate having a first layer and a second layer. The first layer may comprise a paper that is at least partially soluble. The second layer may comprise a film that is at least partially soluble. The first layer has a first paper surface facing towards the second layer, and a second paper surface facing away from the second layer. The second layer has a first film surface facing away from the first layer, and a second film surface facing towards the first layer. At least some of the first paper surface and at least some of the second film surface is partially dissolved during manufacturing to enable the first paper surface and the second film surface to adhere to one another.

The packaging material may be used to contain a food product, a food supplement, a drink ingredient, a pharmaceutical product, a chemical such as a pool chemical, fertilizer, a flushable consumer good, cleaning product, or a laundry detergent.

In certain embodiments, the paper may be a cellulose-based paper. Furthermore, the cellulose-based paper may include a cellulose derivative or other additives. The paper may also or alternatively include a thickener. In some embodiments, the film may include a water-soluble polymer such as polyvinylpyrrolidone (PVP) or polyvinyl alcohol (PVA/PVOH).

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 is an exploded view of an exemplary soluble laminate, according to one or more embodiments discussed herein.

FIG. 2 is a schematic view of the process for forming the laminate of FIG. 1, according to one or more embodiments discussed herein.

FIG. 3 is a schematic view of the formed laminate of FIG. 1 as it exits a pair of rollers, according to one or more embodiments discussed herein.

FIG. 4 is a flow chart that illustrates some of the steps of manufacturing the laminate of FIG. 1, according to one or more embodiments discussed herein.

### DETAILED DESCRIPTION OF THE EMBODIMENTS

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

As used throughout, ranges are used as shorthand for describing each and every value that is within the range. It should be appreciated and understood that the description in a range format is merely for convenience and brevity and should not be construed as an inflexible limitation on the scope of any embodiments or implementations discussed herein. Accordingly, the range should be construed to have specifically included all the possible subranges as well as individual numerical values within that range. As such, any value within the range may be selected as the terminus of the range. For example, description of a range such as from 1 to 5 should be considered to have specifically included subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges discussed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is discussed herein, any numerical value falling within the range is also specifically included.

As used herein, the expression “free” of a material or substance may refer to a composition, component, or phase where the material is present in an amount of less than 1.0 wt %, less than 0.1 wt %, less than 0.05 wt %, less than 0.01 wt %, less than 0.005 wt %, or less than 0.0001 wt %, based on a total weight of the composition, component, or phase. As used herein, the expression “substantially free” of a material or substance may refer to a composition, component, or phase where the material is present in an amount of from about 1.0 wt % or more to less than 20.0 wt %, less than 10.0 wt %, less than 5.0 wt %, less than 3.0 wt %, less than 2.0 wt %, less than 1.8 wt %, or less than 1.5 wt %.

All references cited herein are hereby incorporated by reference in their entireties. In the event of a conflict in a definition with a cited reference, the present teachings control.

As mentioned above, there is provided herein a soluble laminate formed from a soluble paper directly attached to or coupled with a soluble film that does not require an adhesive or other layer between the paper and film. The paper and film may be water soluble in one embodiment. In another embodiment, the paper and film may be soluble in a liquid other than water.

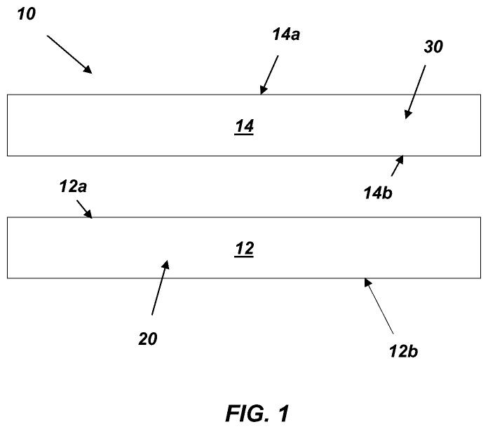

Turning now to the drawings, FIG. 1 illustrates an exploded view of an exemplary embodiment of a water-soluble laminate 10 having a first layer 12 and a second layer 14. The first layer 12 may comprise a paper 20 that is at least partially soluble, such as a water soluble or liquid soluble paper. The second layer 14 may comprise a film 30 that is at least partially soluble. The first layer 12 has a first paper surface 12a facing towards the second layer 14, and a second paper surface 12 b facing away from the second layer 14. The second layer 14 has a first film surface 14a facing away from the first layer, and a second film surface 14b facing towards the first layer 12. At least some of the first paper surface 12a and at least some of the second film surface 14b may be partially dissolved, wetted, and/or softened during manufacturing to enable the first paper surface 12a and the second film surface 14b to adhere to one another. It should be appreciated that partially dissolving, wetting, and/or softening the first paper surface 12a may increase a tackiness thereof, thereby facilitating the adhesion of the first paper surface 12a with the second layer 14.

As illustrated in FIG. 1, the laminate 10 may be free or substantially free of any adhesive or adhesive layer interposed between the first layer 12 and the second layer 14. Accordingly, the first layer 12 and the second layer 14 may be directly coupled with one another without an external adhesive or adhesive agent. As described herein, the first layer 12 and the second layer 14 may be coupled with one another by wetting, partially dissolving, and/or softening the respective interfacing surfaces 12a, 14b of the first layer 12 and the second layer 14. It should be appreciated that partially dissolving, wetting, and/or softening the first paper surface 12a may increase a tackiness thereof, thereby facilitating the adhesion of the first layer 12 or the first paper surface 12a thereof with the second layer 14. It should further be appreciated that upon drying the softened, partially dissolved, and/or wetted first paper surface 12a the first paper surface 12a may remain adhered to the second layer 14. Without being bound by theory, it is believed that polymer fibers of the first layer 12 or the first paper surface 12a thereof may interact physically and/or chemically with the second layer 14 to facilitate the adhesion. The interaction may be or include, but are not limited to, entanglement of the polymer fibers with the second layer 14 and/or components thereof, intermolecular attraction (e.g., Van der Waals, etc.), electrostatic forces, chemical bonding, mechanical interlocking, diffusive adhesion, or the like, or any combination thereof. As used herein, the term or expression mechanical interlocking may refer to the penetration or partial penetration of a first material or layer into pores and/or surfaces (e.g., rough surfaces) of a second material or layer, and the subsequent hardening of the first material, thereby creating a physical locking interaction. As used herein, the term or expression diffusive adhesion may refer to polymer chains of a first material or layer intermingling with a second material or layer forming entangled regions.

In one aspect, a process by which a water-soluble laminate is formed from a water-soluble paper and a water-soluble film is provided. The first layer or paper 12 and the second layer or film 14 may be joined together by wetting, with water, the water-soluble paper 12 and applying the water-soluble film 14 to the wetted water-soluble paper 12 or contacting the water-soluble film 14 with the wetted water-soluble paper 12. Preferably, just enough water is used to wet the water-soluble paper 12 so as to render at least some of the first paper surface 12a of the paper 12 soluble (i.e., partially dissolved) but not so much water so as to allow the water to penetrate deeper into the substrate of the paper 12.

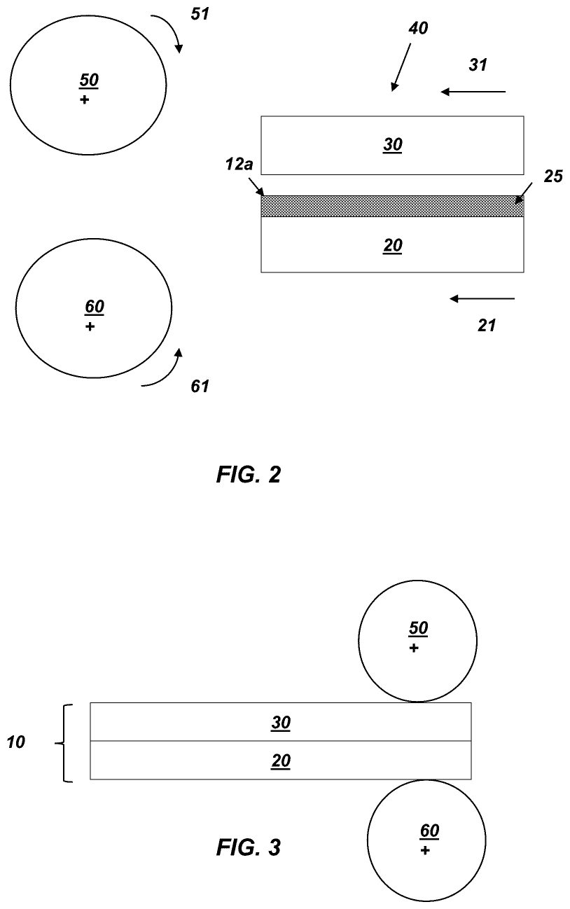

FIG. 2 illustrates schematically a system 40 for forming the laminate 10, in accordance with various embodiments. FIG. 2 illustrates a water-soluble paper 20 and a water-soluble film 30. In this embodiment, the water-soluble paper 20 has its first paper surface 12a wetted with water 25. Preferably, just enough water 25 may be used to wet the water-soluble paper 20 so as to at least partially dissolve a portion of the first paper surface 12a of the paper 20, but not so much water 25 so as to allow the water 25 to penetrate deeper into the substrate of the water-soluble paper 20.

The water-soluble paper 20 and the water-soluble film 30 may be fed in directions 21 and 31, respectively, towards rollers 50 and 60. The rollers 50 and 60 may be rotating in directions 51 and 61, respectively, so as to place the water-soluble paper 20 and the water-soluble film 30 into direct, e.g., intimate, contact with each other. As shown in FIG. 3, the water-soluble film 30 may be brought into direct contact with the wetted water-soluble paper 20 at the nip of the rollers 50, 60, with the rollers 50 and 60 functioning to ensure sufficient pressure on the water-soluble paper 20 and the water-soluble film 30, thereby ensuring that they form a consistent laminate 10. More specifically, the rollers 50 and 60 may function to press the entire water-soluble film 30 against the wetted water-soluble paper 20 to thereby bond them together to form the laminate 10. It is understood, of course, that in an alternative embodiment, the water-soluble film 30 can be brought into direct contact with the wetted water-soluble paper 20 before the layers 20 and 30 enter the nip of the rollers.

In embodiments in which the rollers 50 and 60 are heated, the rollers 50 and 60 may also function to help dry the water 25 between the water-soluble paper 20 and the water-soluble film 30. Additionally or alternatively, the laminate 10 may undergo a separate subsequent drying process to ensure that the water 25 is completely evaporated and the water-soluble paper 20 and the water-soluble film 30 are completely connected.

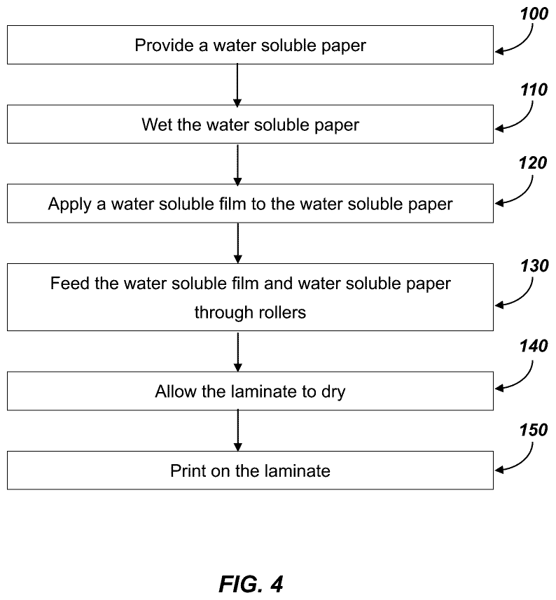

FIG. 4 is a flow chart that illustrates various steps of manufacturing the laminate 10 from the water-soluble film 30 and the water-soluble paper 20, in accordance with various embodiments. As shown in FIG. 4, at step 100, there is provided a water-soluble paper 20. At step 110, the water-soluble paper 20 may be wetted with water 25. At step 120, the water-soluble film 30 may be applied to the wetted water-soluble paper 20. At step 130, the water soluble paper 20 and the water soluble film 30 may be brought into intimate, e.g., direct, contact with each other, such as by being fed through rollers 50 and 60. At step 140, the water soluble paper 20 and the water soluble film 30 may be allowed to dry, either or both by using heated rollers 50 and 60 and/or by performing a separate subsequent drying process so as to dry the laminate 10. At step 150, the laminate 10 may be printed on, as set forth in greater detail below. The resulting laminate 10 may be particularly well suited for use in many commercial applications such as, for example, packaging for food, pharmaceuticals, washing detergents, etc., and particularly for any applications that might benefit from the elimination of adhesives or other layers between the water-soluble paper 20 and the water-soluble film 30.

As set forth above, various different types of the water-soluble paper 20 are contemplated for use in forming the laminate 10. For example, the water-soluble paper 20 may be made or various different materials and/or be made by various different processes. Suitable types of soluble paper may include any liquid or water-soluble paper. The paper 20 may be, in one example, a water-soluble filamentous paper formed by a paper machine, a web, or it may be spunbond, meltblown, airlaid, or needle punched.

In certain embodiments, the water-soluble paper 20 may be a cellulose-based paper. Furthermore, the cellulose-based paper may include a cellulose derivative or other additives. Suitable additives may include, for example, aqueous based, water re-dispersible adhesives including, but not limited to, one or more of carboxymethyl cellulose (CMC), hydroxyethyl cellulose (HEC), starches, starch derivatives, alginates, xanthan, pectins, cellulose gums, sugars, PEG, PVOH, PVP, polyacrylamides, hydrophilic acrylic copolymers, or the like, or any combination thereof.

Still further, the cellulose-based paper may include a thickener, such as a carboxymethyl cellulose thickener, or a thickener including HEC, starches, starch derivatives, alginates, xanthan, pectins, cellulose gums, sugars, PEG, PVOH, PVP, polyacrylamides, hydrophilic acrylic copolymers, etc. as long as they don't impede the dissolution of the final laminate.

Furthermore, it is contemplated that the water-soluble paper 20 may have any number of different thicknesses or stocks. For example, the water-soluble paper 20 may have a thickness between about 0.02 and about 0.90 millimeters. In an embodiment, the water-soluble paper 20 may be Dispersa®, a product publicly available from Neenah Industrials Solutions, Alpharetta, GA. For example, the water-soluble paper 20 may be or include Dispersa® 7741P0, Dispersa® 7742P0, or a combination thereof.

In at least one embodiment, the water-soluble paper 20 may have a basis weight (lbs. per 3,000 ft) of from about 80 to about 100, about 85 to about 95, or about 90.8. The water-soluble paper 20 may also have a basis weight of from about 130 grams per square meter (gsm) to about 170 gsm, about 140 gsm to about 160 gsm, about 145 gsm to about 155 gsm, about 145 gsm to about 150 gsm, or about 148 gsm.

In another embodiment, the water-soluble paper 20 may have a basis weight (lbs. per 3,000 ft) of from about 100 to about 120, about 105 to about 115, about 110 to about 112, or about 111. The water-soluble paper 20 may also have a basis weight of from about 170 gsm to about 190 gsm, about 175 gsm to about 185 gsm, or about 180 to about 181 gsm.

As set forth above, various different types of the water-soluble film 30 are also contemplated for use in forming the laminate 10. For example, the water-soluble film 30 may be made with various different materials and/or be made by various different processes. Suitable types of the soluble film 30 may include any liquid or water-soluble film. For example, the film 30 may include a water-soluble polymer such as polyvinylpyrrolidone (PVP), polyvinyl alcohol (PVA/PVOH), or a combination thereof. In certain embodiments, the water-soluble film 30 may include an alcohol, e.g., a polyvinyl alcohol (PVA/PVOH). In some embodiments, the water-soluble film may be MonoSol™ (a product publicly available from Kuraray™ Company, Merrillville, IN). The water-soluble film 30 may have a thickness of from about 0.01 to about 0.40 millimeters (mm).

It should be understood that what is meant by soluble is that a majority of the material is soluble in liquid, but that modest amounts of insoluble artifacts may be present without negative effects. For instance, modest amounts of insoluble co-polymers at very small amounts, such as less than or equal to about 5%, less than or equal to about 3%, or less, may be acceptably present in the soluble film 30. Furthermore, it is understood that only some of the contact surfaces of the paper 20 and film 30 may need to be wetted or dissolved in order for the paper 20 and film 30 to adhere together. The entire surface area of the contact surfaces is not required to be wetted or dissolved in order to achieve adhesion of the film 30 to the paper 20.

As set forth above, the resulting laminate 10 may be particularly well suited to be printed on, e.g., by virtue of the paper 20 being exposed for printing processes during subsequent manufacturing steps. For example, the resulting laminate 10 may have company logos or brands and/or brand names printed thereon so as to designate the manufacturer or origin of the product. Additionally or alternatively, the resulting laminate 10 may have text and/or characters printed thereon. Indeed, it should be recognized that the resulting laminate 10 may have printed thereon any conceivable type of printing, e.g., letters, characters, numbers, words, pictures, logos, brands, names, etc.

Still further, it should be recognized that the printing on the laminate 10 may be for various different purposes. For example, in various embodiments, the printing on the laminate 10 may be, in the case of company or brand names and/or logos, for the purpose of designating the manufacturer or origin of the product. Additionally or alternatively, the printing on the laminate 10 may be for the purpose of providing instructions to the user for using the product. Still further, the printing on the laminate 10 may be for the purpose of providing safety information to the user. Indeed, it should be recognized that the printing on the resulting laminate 10 may be printed thereon for any conceivable reason.

It should be recognized that the laminates 10 described herein may have various different uses and may be formed into a variety of different shapes to best accomplish such uses. As set forth above, the laminate 10 may be employed in any number of conceivable commercial applications. For example, the laminate 10 may be formed in the shape of pods or pouches for use in, e.g., laundry detergent applications, whereby the pods are intended to be placed into a washing machine and to dissolve once exposed to water. Likewise, the laminate 10 may be formed in the shape of pods or pouches for use in, e.g., food and/or drink applications, such as drink mixes, protein supplements, etc., whereby the pods or pouches may be intended to be placed into a liquid, e.g., water, milk, juice, etc., and to dissolve once exposed to such liquid. Still further, the laminate 10 may be formed in the shape of pods or pouches for use in, e.g., pharmaceutical applications, such as medicinal dosages or vitamin supplements, etc., whereby the pods or pouches are intended to be placed into a liquid, e.g., water, milk, juice, etc., and to dissolve once exposed to such liquid. Even still, additional uses may be for the containment of pool chemicals, fertilizers, and for flushable consumer product packaging. Of course, any conceivable shape and/or use is contemplated herein.

Providing the laminate 10 that does not include an adhesive layer between the water-soluble paper 20 and the water-soluble film 30 during a manufacturing process has several advantages. For example, providing the laminate 10 that does not include applying an adhesive layer between the water-soluble paper 20 and the water-soluble film 30 during a manufacturing process reduces complexity to the manufacturing process, since avoiding the application of an adhesive may help reduce or eliminate complicated processing steps for the adhesive.

In addition, providing the laminate 10 that does not include applying an adhesive layer between the water-soluble paper 20 and the water-soluble film 30 during a manufacturing process may prevent the adhesive from undesirably being part of the final product. More specifically, eliminating an adhesive layer, e.g., glue, between the water-soluble paper 20 and the water-soluble film 30 during a manufacturing process, and employing water instead, may result in a product that, when introduced to water during use, allows the water-soluble paper 20 and the water-soluble film 30 to dissolve while leaving no adhesive present. In applications such as, e.g., food and pharmaceutical packaging, having the water-soluble paper 20 and the water-soluble film 30 dissolve in water, without there being an adhesive left behind, may help avoid an adhesive being undesirably ingested by the user. This may be advantageous in other types of applications too, specifically in any application in which it may be desirable not to have some or all of an adhesive layer remain present after a packaging formed from the water-soluble paper 20 and/or the water-soluble film 30 dissolves in water during use. Another advantage is the relatively faster speed with which the laminate 10 can fully dissolve, releasing its contents quicker where such an attribute is desirable.

For purposes of illustration, the embodiments are described with reference to certain applications. However, the embodiments may be implemented in any application of a laminate formed by a water-soluble paper with a water-soluble film. Further, it is understood that the illustrations are not drawn to scale and therefore is not intended to limit the invention in any way.

The following numbered paragraphs are directed to one or more exemplary variations of the subject matter of the application:
1. A laminate, comprising: a first layer comprising a paper that is at least partially soluble; and a second layer comprising a film that is at least partially soluble; the first layer having a first paper surface facing towards the second layer, and a second paper surface facing away from the second layer, the second layer having a first film surface facing away from the first layer, and a second film surface facing towards the first layer; wherein at least some of the first paper surface and at least some of the second film surface is partially dissolved and adhered to one another.
2. The laminate of paragraph 1, wherein the first and second layers are water soluble.
3. The laminate of paragraph 1 or 2, wherein the laminate is water soluble.
4. The laminate of any one of paragraphs 1 to 3, wherein the first layer comprises a cellulose-based paper.
5. The laminate of paragraph 4, wherein the cellulose-based paper includes a cellulose derivative or an aqueous based, water re-dispersible adhesive selected from the group consisting of carboxymethyl cellulose (CMC), hydroxyethyl cellulose (HEC), starches, starch derivatives, alginates, xanthan gum, pectins, cellulose gums, sugars, polyethylene glycol (PEG), polyvinyl alcohol (PVOH), polyvinylpyrrolidone (PVP), polyacrylamides, hydrophilic acrylic copolymers, and combinations thereof.
6. The laminate of paragraph 4 or 5, wherein the cellulose-based paper includes a thickener selected from the group consisting of carboxymethyl cellulose (CMC), hydroxyethyl cellulose (HEC), starches, starch derivatives, alginates, xanthan gum, pectins, cellulose gums, sugars, polyethylene glycol (PEG), polyvinyl alcohol (PVOH), polyvinylpyrrolidone (PVP), polyacrylamides, hydrophilic acrylic copolymers, and combinations thereof.
7. The laminate of any one of paragraphs 1 to 6, wherein the first layer has a thickness in the range of from about 0.02 mm to about 0.90 mm.
8. The laminate of any one of paragraphs 1 to 7, wherein the second layer comprises a polymer.
9. The laminate of paragraph 8, wherein the polymer comprises polyvinylpyrrolidone (PVP) or polyvinyl alcohol (PVA/PVOH).
10. The laminate of any one of paragraphs 1 to 9, wherein the second layer has a thickness in the range of from about 0.01 mm to about 0.40 mm.
11. The laminate of any one of paragraphs 1 to 10, further being configured for printing thereon.
12. A process for forming a laminate, comprising: providing a first layer comprising a paper that is at least partially soluble, the paper having a first paper surface and a second paper surface; providing a second layer comprising a film that is at least partially soluble, the film having a first film surface and a second film surface; wetting the first paper surface with a liquid; and applying the second layer onto the first layer such that the second film surface faces and adheres to the first paper surface.
13. The process of paragraph 12, wherein applying the second layer onto the first layer includes placing the second layer onto the first layer between rollers.
14. The process of paragraph 13, wherein the rollers are heated rollers.
15. The process of any one of paragraphs 12 to 14, wherein wetting the first paper surface with the liquid comprises applying the liquid to at least partially dissolve the first paper surface.
16. The process of paragraph 15, wherein the liquid comprises water.
17. The process of paragraph 15 or 16, wherein wetting the first paper surface with the liquid does not fully dissolve the first layer.
18. The process of any one of paragraphs 12 to 17, wherein the paper of the first layer comprises a cellulose-based paper.
19. The process of paragraph 18, wherein the cellulose-based paper includes a cellulose derivative or an aqueous based, water re-dispersible adhesive selected from the group consisting of carboxymethyl cellulose (CMC), hydroxyethyl cellulose (HEC), starches, starch derivatives, alginates, xanthan gum, pectins, cellulose gums, sugars, polyethylene glycol (PEG), polyvinyl alcohol (PVOH), polyvinylpyrrolidone (PVP), polyacrylamides, hydrophilic acrylic copolymers, and combinations thereof.
20. The process of paragraph 18 or 19, wherein the cellulose-based paper includes a thickener selected from the group consisting of carboxymethyl cellulose (CMC), hydroxyethyl cellulose (HEC), starches, starch derivatives, alginates, xanthan gum, pectins, cellulose gums, sugars, polyethylene glycol (PEG), polyvinyl alcohol (PVOH), polyvinylpyrrolidone (PVP), polyacrylamides, hydrophilic acrylic copolymers, and combinations thereof.
21. The process of any one of paragraphs 12 to 20, wherein the first layer has a thickness in the range of from about 0.02 mm to about 0.90 mm.
22. The process of any one of paragraphs 12 to 21, wherein the film of the second layer comprises a polymer.
23. The process of paragraph 22, wherein the polymer comprises polyvinylpyrrolidone (PVP) or polyvinyl alcohol (PVA/PVOH).
24. The process of any one of paragraphs 12 to 23, wherein the second layer has a thickness in the range of from about mm 0.01 to about 0.40 mm.
25. The process of any one of paragraphs 12 to 24, further comprising printing on the laminate.
26. A laminated paper, comprising: a first layer comprising a paper that is at least partially soluble; and a second layer comprising a film that is at least partially soluble; the first layer having a first paper surface facing towards the second layer, and a second paper surface facing away from the second layer, the second layer having a first film surface facing away from the first layer, and a second film surface facing towards the first layer; wherein at least some of the first paper surface and at least some of the second film surface is partially dissolved and adhered to one another.
27. The laminated paper of paragraph 26, wherein the first and second layers are water soluble.
28. The laminated paper of paragraph 26 or 27, wherein the laminate is water soluble.
29. The laminated paper of any one of paragraphs 26 to 28, wherein the first layer comprises a cellulose-based paper.
30. The laminated paper of paragraph 29, wherein the cellulose-based paper includes a cellulose derivative or an aqueous based, water re-dispersible adhesive selected from the group consisting of CMC, HEC, starches, starch derivatives, alginates, xanthan, pectins, cellulose gums, sugars, PEG, PVOH, PVP, polyacrylamides, and hydrophilic acrylic copolymers.
31. The laminated paper of paragraph 29 or 30, wherein the cellulose-based paper includes a thickener selected from the group consisting of carboxymethyl cellulose (CMC), hydroxyethyl cellulose (HEC), starches, starch derivatives, alginates, xanthan, pectins, cellulose gums, sugars, polyethylene glycol (PEG), polyvinyl alcohol (PVOH), polyvinylpyrrolidone (PVP), polyacrylamides, hydrophilic acrylic copolymers, and combinations thereof.
32. The laminated paper of any one of paragraphs 26 to 31, wherein the first layer has a thickness in the range of from about 0.02 mm to about 0.90 mm.
33. The laminated paper of any one of paragraphs 26 to 32, wherein the second layer comprises a polymer.
34. The laminated paper of paragraph 33, wherein the polymer comprises polyvinylpyrrolidone (PVP) or polyvinyl alcohol (PVA/PVOH).
35. The laminated paper of any one of paragraphs 26 to 34, wherein the second layer has a thickness in the range of from about 0.01 mm to about 0.40 mm.
36. The laminated paper of any one of paragraphs 26 to 35, further having printing thereon.
37. A packaging material for containing a product, comprising: a laminate having a first layer comprising a paper that is at least partially soluble; and a second layer comprising a film that is at least partially soluble; the first layer having a first paper surface facing towards the second layer, and a second paper surface facing away from the second layer, the second layer having a first film surface facing away from the first layer, and a second film surface facing towards the first layer; wherein at least some of the first paper surface and at least some of the second film surface is partially dissolved and adhered to one another.
38. The packaging material of paragraph 37, further being configured to dissolve in water.
39. The packaging material of paragraph 37 or 38, wherein the product is a food product, a food supplement, a drink ingredient, a pharmaceutical product, a chemical, fertilizer, a flushable consumer good, a cleaning product, or a laundry detergent.
40. The packaging material of any one of paragraphs 37 to 39, wherein the paper comprises a cellulose-based paper.
41. The packaging material of any one of paragraphs 37 to 40, wherein the film comprises a polymer.
42. The packaging material of paragraph 41, wherein the polymer comprises polyvinylpyrrolidone (PVP) or polyvinyl alcohol (PVA/PVOH).
43. The packaging material of any one of paragraphs 37 to 42, further having printing thereon.

### EXAMPLES

The examples and other implementations described herein are exemplary and not intended to be limiting in describing the full scope of compositions and methods described herein. Equivalent changes, modifications, and variations of specific implementations, materials, compositions, and methods may be made within the scope of the implementations or embodiments described herein, with substantially similar results.

### Example 1

Exemplary laminates (1)-(3) were prepared by laminating PVOH films to cellulose-based paper. Particularly, PVOH films, namely Kuraray™ MonoSol™ PVOH films having a thickness of about 3.0 mils and about 1.5 mils were laminated with Dispersa® paper. To prepare the exemplary laminates (1)-(3), The Dispersa® paper was disposed on an unwind stand and threaded through a laminator, namely a Dahlgren laminator, where water was applied to wet, soften, and/or at least partially dissolve a surface of the Dispersa® paper. The sheet was then directed over a bowed roll before entering the nip of the rollers, namely, a Chrome roll and a Hypalon™ roll. The PVOH film was mounted to an unwind stand by the Hypalon™ roll. The laminates (1) and (2) were prepared with the Hypalon™ roll wrapped with pallet wrap to prevent the MonoSol™ PVOH film from sticking to the Hypalon™ roll. The laminate (3) was prepared with the Hypalon™ roll unwrapped. The PVOH film was directed into the nip over the Hypalon™ roll where it was laminated to the wetted Dispersa® paper. A standard web path was used after lamination to the unwind stand. Process conditions for each of the exemplary laminates (1)-(3) are summarized in Table 1.

TABLE 1

| | (1) | (2) | (3) |
|---|---|---|---|
| Process | Cellulose-Based Paper | Cellulose-Based Paper | Cellulose-Based Paper |
| Conditions | with 3.0 Mil PVOH film | with 1.5 Mil PVOH film | with 1.5 Mil PVOH film |
| Nip Pressure | 300 | 450 | 500 |
| (PSI) | | | |
| Nip Roll Trim | −1 | −1 | −1 |
| Adjustment | | | |
| Line Speed | 50 | 50 | 50 |
| (fpm) | | | |
| Laminator | 44 | 43 | 42 |
| Operator Side | | | |
| Setting | | | |
| Laminator | 62 | 61 | 61 |
| Drive Side | | | |
| Setting | | | |
| Moisture Application | 900 | 900 | 900 |
| (Chrome Roll Speed) | | | |
| (fpm) | | | |
| Rewind Stand | 0.5 | 1 | 1 |
| Down Pressure | | | |
| Winder Tension | 15 | 15 | 15 |
| (psi) | | | |
| Hypalon Roll | Wrapped | Wrapped | Unwrapped |

Each of the laminates (1)-(3) were evaluated for varying properties, including: paper width; film width; color change in laminate vs cellulose-based paper; and moisture. The color change and moisture were both evaluated directly off the laminator (Time=0) and upon aging. Specifically, the color was evaluated about three (3) days after lamination (Time=3 days) and the moisture was evaluated about six (6) days after lamination (Time=6 days). The color was evaluated via delta E CMC (dE CMC), which determines the total distance or difference between two colors. Delta E CMC is an elliptical tolerance that was developed by the Color Measurement Committee of the Society of Dyers and Colorists and is a conventional method of determining changes in color and/or color differences. The width measurements were evaluated via a calibrated ruler. The moisture content was measured by determining mass at time=0 with a scale/balance. Specifically, the moisture loss was determined with an IR Moisture Balance/Analyzer, which is commercially available from Mettler Toledo of Columbus, OH. The results are summarized in Table 2.

This trial was able to successfully laminate the PVOH films to the cellulose-based Dispersa® paper.

TABLE 2

| | Paper | Film | Color of Laminate | Color of Laminate | Moisture | Moisture |
|---|---|---|---|---|---|---|
| | Width | Width | Vs. cellulose paper | Vs. cellulose paper | Time = 0 | Time = 6 d |
| Sample | (in) | (in) | (dE CMC @ Time = 0) | (dE CMC @ Time = 3 d) | (%) | (%) |
| (1) | 56.35 | 50.94 | 3.40 | 3.67 | 9.01 | 4.05 |
| (2) | 56.44 | 51.15 | 2.57 | 3.24 | 8.22 | 4.70 |
| (3) | 56.44 | 51.00 | 0.53 | 0.78 | 9.10 | 5.52 |

As illustrated in Table 2, the laminates (1)-(3) were successfully prepared from a water-soluble film (e.g., PVOH film) and a water-soluble paper (e.g., cellulose-based paper). It was surprisingly and unexpectedly discovered that each of the laminates (1)-(3) were capable of being prepared without the use of an adhesive and/or an adhesive layer interposed between the water-soluble film and the water-soluble paper. Specifically, the water-soluble film was effectively laminated or coupled with the water-soluble paper with the addition of water to wet the contact or interfacing surface of the water-soluble paper. The discovery was both surprising and unexpected as water would be expected to dissolve the water-soluble paper and/or the water-soluble film during the manufacturing process, thereby preventing the lamination therebetween.

While the devices, systems, and methods have been described in detail herein in accordance with certain preferred implementations thereof, many modifications and changes therein may be affected by those skilled in the art. Accordingly, the foregoing description should not be construed to be limited thereby but should be construed to include such aforementioned obvious variations and be limited only by the spirit and scope of the following claims.

What is claimed is:

1. A laminate, comprising:
a first layer comprising a paper that is at least partially soluble; and
a second layer comprising a film that is at least partially soluble;
the first layer having a first paper surface facing towards the second layer, and a second paper surface facing away from the second layer, the second layer having a first film surface facing away from the first layer, and a second film surface facing towards the first layer;
wherein at least some of the first paper surface and at least some of the second film surface is partially dissolved and adhered to one another.

2. The laminate of claim 1, wherein the first and second layers are water soluble.

3. The laminate of claim 1, wherein the first layer comprises a cellulose-based paper.

4. The laminate of claim 3, wherein the cellulose-based paper includes a cellulose derivative or an aqueous based, water re-dispersible adhesive selected from the group consisting of carboxymethyl cellulose (CMC), hydroxyethyl cellulose (HEC), starches, starch derivatives, alginates, xanthan gum, pectins, cellulose gums, sugars, polyethylene glycol (PEG), polyvinyl alcohol (PVOH), polyvinylpyrrolidone (PVP), polyacrylamides, hydrophilic acrylic copolymers, and combinations thereof.

5. The laminate of claim 3, wherein the cellulose-based paper includes a thickener selected from the group consisting of carboxymethyl cellulose (CMC), hydroxyethyl cellulose (HEC), starches, starch derivatives, alginates, xanthan gum, pectins, cellulose gums, sugars, polyethylene glycol (PEG), polyvinyl alcohol (PVOH), polyvinylpyrrolidone (PVP), polyacrylamides, hydrophilic acrylic copolymers, and combinations thereof.

6. The laminate of claim 1, wherein the first layer has a thickness in the range of from about 0.02 mm to about 0.90 mm.

7. The laminate of claim 1, wherein the second layer comprises a polymer.

8. The laminate of claim 7, wherein the polymer comprises polyvinylpyrrolidone (PVP) or polyvinyl alcohol (PVA/PVOH).

9. The laminate of claim 1, wherein the second layer has a thickness in the range of from about 0.01 mm to about 0.40 mm.

10. The laminate of claim 1, further being configured for printing thereon.

11. A laminated paper, comprising the laminate of claim 1.

12. A packaging material for containing a product, comprising the laminate of claim 1.

13. The packaging material of claim 12, wherein the packaging material is configured to dissolve in water.

14. The packaging material of claim 12, wherein the product is a food product, a food supplement, a drink ingredient, a pharmaceutical product, a chemical, fertilizer, a flushable consumer good, a cleaning product, or a laundry detergent.

15. The packaging material of claim 12, further comprising printing thereon.

16. A process for forming a laminate, comprising:
providing a first layer comprising a paper that is at least partially soluble, the paper having a first paper surface and a second paper surface;
providing a second layer comprising a film that is at least partially soluble, the film having a first film surface and a second film surface;
wetting the first paper surface with a liquid; and
applying the second layer onto the first layer such that the second film surface faces and adheres to the first paper surface.

17. The process of claim 16, wherein applying the second layer onto the first layer includes placing the second layer onto the first layer between rollers.

18. The process of claim 16, wherein the rollers are heated rollers.

19. The process of claim 16, wherein wetting the first paper surface with the liquid comprises applying the liquid to at least partially dissolve the first paper surface.

20. The process of claim 19, wherein the liquid comprises water.

21. The process of claim 19, wherein wetting the first paper surface with the liquid does not fully dissolve the first layer.

22. The process of claim 16, wherein the paper of the first layer comprises a cellulose-based paper.

23. The process of claim 16, wherein the film of the second layer comprises a polymer.

24. The process of claim 23, wherein the polymer comprises polyvinylpyrrolidone (PVP) or polyvinyl alcohol (PVA/PVOH).

25. The process of claim 16, further comprising printing on the laminate.
